(19) United States
(12) Patent Application Publication
(10) Pub. No.: US 2015/0177963 A1
(43) Pub. Date: Jun. 25, 2015

(54) METHOD FOR SELECTING AN ELECTRONIC CONTENT TO BE DISPLAYED ON A DISPLAY OF AN ELECTRONIC DEVICE

(71) Applicant: Orange, Paris (FR)

(72) Inventor: Menghuai Huang, Beijing (CN)

(21) Appl. No.: 14/578,363

(22) Filed: Dec. 20, 2014

(30) Foreign Application Priority Data
Dec. 20, 2013 (CN) PCT/CN2013/090064

(51) Int. Cl. G06F 3/0484

(52) U.S. Cl. CPC G06F 3/04845; G06F 3/04842

(57) ABSTRACT

A method is provided for selecting an electronic content to be displayed on a display of an electronic device controlled by a user interface, a first electronic content already being displayed on the display of the electronic device. The method includes: detecting a first input on a first specific element of the user interface, the specific element pointing toward at least a second electronic content to be displayed, displaying at least a portion of the second electronic content on the display of the electronic device, the portion of the second electronic content overlapping the first electronic content, detecting a second input on a second specific element of the user interface, the detection triggering the display of the second electronic content on the display of the electronic device.

### FIELD OF THE DISCLOSURE

The present disclosure generally relates to methods for displaying electronic contents on electronic devices.

### BACKGROUND OF THE DISCLOSURE Browsers have been developed for mobile devices, such as Smartphones or tablets, such as Mobile Chrome™. Such browsers allow the display of multiple electronic contents such as WebPages multiples windows.

In known browsers, in order to display different electronic contents, a user select the link pointing toward the electronic content they wish to access, e.g. an URL pointing toward a press article. However, due to the small size of the screens of electronic devices, selecting a link pointing toward a given electronic content can be tricky and the user can easily select a link pointing toward another electronic content resulting in a wrong electronic content to be displayed on the screen of the electronic device of the user.

In order to overcome such drawbacks, some browsers propose to display a dialog box containing zoomed in links. When two links are very close to each other and the electronic device cannot determine with certainty which one of the two links the user want to activate, then a dialog box containing an enlargement of the two links is displayed. The user of the electronic device then selects the desired link for example by touching it.

Such a method although being efficient in selecting the desired link, is not user friendly since the user must repeatedly select a link by touching it in different dialog boxes, until there is no more ambiguity on the link they want to activate.

### SUMMARY

An exemplary embodiment of the present disclosure relates to a method for selecting an electronic content to be displayed on a display of an electronic device controlled by means of a user interface, a first electronic content already being displayed on the display of the electronic device, said method comprising the steps of:
Detecting a first input on a first specific element of the user interface, said specific element pointing toward at least a second electronic content to be displayed,
Displaying at least a portion of the second electronic content on the display of the electronic device, said portion of the second electronic content overlapping the first electronic content, a measurement of the portion of the second electronic content to be displayed being proportional to an offset between a starting position of a second input on a second specific element of the user interface of the electronic device and an ending position of the second input on a third specific element of the user interface of the electronic device,
Detecting a third input on a third specific element of the user interface, said detection triggering the display of the second electronic content on the display of the electronic device.

This method allows a user of an electronic device to select at least one link, such as a hyperlink, pointing towards electronic contents to be displayed on a display of their electronic device among a plurality of links touched by the user of the electronic device.

Indeed, since the size of a specific element of the user interface of the electronic device corresponding to a hyperlink is small comparing to the size of a portion of the user interface of the electronic device touched by a finger of the user of the electronic device, more than one hyperlink can be activated by the user, making the selection of the electronic content to be displayed quite tricky.

In order to select the right electronic content to be displayed on the display of the electronic device, the method includes, while a first electronic content is already displayed on the display of the electronic device in displaying a portion of the second electronic contents, towards which the activated hyperlinks are pointing, on the display of the electronic device, said portions of the second electronic contents overlapping the first electronic content already displayed. Thus, the user of the electronic device can see on the display of their electronic device the first electronic content overlapped by the stored electronic contents and hence can see a part of the electronic contents.

Thus, the second electronic content moves into the display of the electronic device from, for example, an edge of the display of the electronic device, the surface of the second electronic content overlapping the first electronic content being proportional to the distance between the starting position and the ending position of the second input on the user interface of the electronic device.

When the second input is a sliding gesture or a pinch gesture, the surface of the second electronic content overlapping the first electronic content is proportional to the length of the sliding gesture; i.e. the longer the sliding gesture the bigger the surface overlapping the first electronic content.

The user of the electronic device then touch a third specific element of the user interface of their electronic device in order to select which one of the stored electronic contents is to be displayed on the display of the electronic device instead of the first electronic content.

Such a method improves the quality of experience of the user because they can select the electronic content to be displayed on the display of their electronic device without the user having to make many tap gestures to select the right electronic content. Furthermore, the user being capable of seeing a part of the second electronic content before selecting it, they select the electronic content to be displayed based on what they see of the electronic content and not based only on a hyperlink which is not representative of the electronic content.

The electronic device of the user can be for example a mobile phone, a Smartphone, a tablet, a laptop, an e-reader, etc.

The electronic device of the user comprises a display, and a user interface, such as a keyboard, or a keyboard and pointing means such as a mouse. In some embodiments, the display and the user interface can be one and the same, it is the case for example of touch-screens.

Thus, a specific element of the user interface can be a key of a key board, a combination of keys, a button of the pointing means, a specific area of a touch-screen, etc.

An input can be a keystroke or a combination of keystrokes, a combination of keystroke and an action of the pointing means, e.g. highlighting a link currently displayed using the pointing means and striking a key of the keyboard.

In the case of touch-screens, an input can be a specific gesture on a specific area of the screen, such as a clutch gesture or a pinch gesture, etc.

According to a feature of the method, the third specific element is a given area of the portion of the second electronic content overlapping the first electronic content.

Thus the user of the electronic device only have to touch an area of the portion of the second electronic content for the second electronic content to be displayed in instead of the first electronic content. Such a solution requires minimal user intervention to select an electronic content to be displayed.

The method further comprises the steps of:
Determining whether the ending position of the second input on the third specific element of the user interface is beyond a threshold,
If so, the third input being a release of the second input, triggering the display of the second electronic content on the display of the electronic device.

If the sliding gesture is longer than a threshold, then the second electronic content is considered selected by the user of the electronic device, hence the second electronic content is displayed on the display of the electronic device instead of the first electronic content.

Another aspect of the disclosure relates to an electronic device controlled by means of a user interface and operable to select an electronic content to be displayed on a display of the electronic device on which a first electronic content already is displayed, the electronic device comprising means for:
Detecting a first input on a first specific element of the user interface, said specific element pointing toward at least a second electronic content to be displayed,
Displaying at least a portion of the second electronic content on the display, said portion of the second electronic content overlapping the first electronic content, a measurement of the portion of the second electronic content to be displayed being proportional to an offset between a starting position of a second input on a second specific element of the user interface of the electronic device and an ending position of the second input on a third specific element of the user interface of the electronic device,
Detecting a third input on a second specific element of the user interface, said detection triggering the display of the second electronic content on the display of the electronic device.

The electronic device of the user can be for example a mobile phone, a Smartphone, a tablet, a laptop, an e-reader, etc.

The electronic device of the user comprises a display, and a user interface, such as a keyboard, or a keyboard and pointing means such as a mouse. In some embodiments, the display and the user interface can be one and the same, it is the case for example of touch-screens.

Finally, an aspect of the disclosure concerns a computer program, in particular a computer program on or in an information medium or memory, suitable for implementing the method. This program can use any programming language, and be in the form of source code, binary code, or of code intermediate between source code and object code such as in a partially compiled form, or in any other desirable form for implementing the communication methods according to the disclosure.

The information medium may be any entity or device capable of storing the programs. For example, the medium can comprise a storage means, such as a ROM, for example a CD ROM or a microelectronic circuit ROM, or else a magnetic recording means, for example a diskette (floppy disk) or a hard disk.

Moreover, the information medium may be a transmissible medium such as an electrical or optical signal, which may be conveyed via an electrical or optical cable, by radio or by other means. The program according to the disclosure may in particular be downloaded from a network of Internet type.

### BRIEF DESCRIPTION OF THE DRAWINGS

The present system and method are explained in further detail, and by way of example, with reference to the accompanying drawings wherein:

FIG. 1 represents an electronic device capable of running the method for selecting an electronic content to be displayed object of the disclosure,

FIG. 2 represents a diagram representing the steps of the method as experienced by the user,

FIG. 3 represents the electronic device while running the method for selecting an electronic content to be displayed object of the disclosure,

FIG. 4 represents a diagram representing the steps of the method when it is run by the electronic device,

FIG. 5 represents an electronic device capable of running the method.

### DETAILED DESCRIPTION OF ILLUSTRATIVE EMBODIMENTS

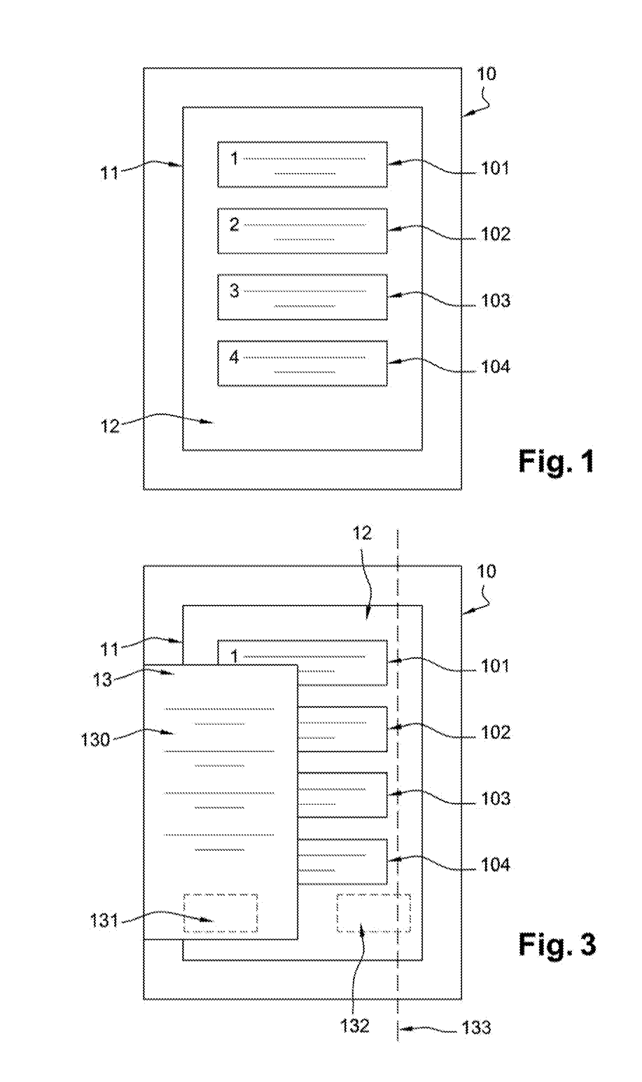

FIG. 1 represents an electronic device 10 comprising a graphical user interface 11, e.g. a touch-screen, acting both as a display and a user interface controlling the display.

The electronic device 10 is capable of launching a browser or an application, such as for example a news application.

When the browser is running, the electronic device 10 displays a first electronic content 12, e.g. a webpage, displaying for example hyperlinks 1-4 corresponding to the results of a search executed by a search engine. The hyperlinks 1-4 can be, for example, URL pointing toward different electronic contents such as press articles, videos, pictures, WebPages, etc.

The surface of the graphical user interface 11 comprises four specific elements 101-104 of the graphical user interface 11, each of which corresponds to a hyperlink 1-4.

In other embodiments, the electronic device 10 comprises a display and a user interface distinct from each other. The user interface 11 can be a keyboard, or a keyboard and pointing device such as a mouse. Thus, a specific element of the user interface 11 can be a key of a key board, a combination of keys, a button of the pointing device, a specific area of a touch-screen, etc.

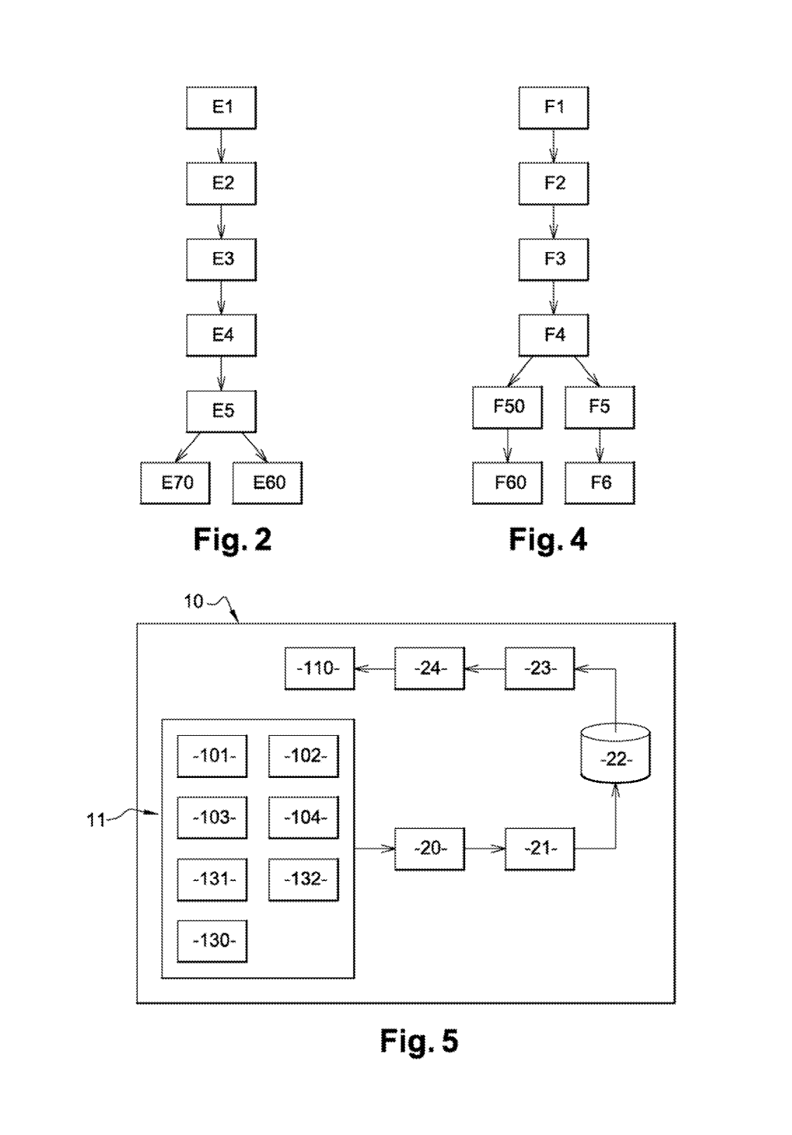

FIG. 2 shows a diagram representing the steps of the method of the disclosure as experienced by the user.

In a step E1, a first electronic document 12 is displayed on the graphical user interface 11. Such a document is for example a webpage comprising a plurality of hyperlinks pointing toward other electronic contents such as videos, pictures, other WebPages, etc.

The user of the electronic device 10 whishes to access at least one of the electronic contents associated to the hyperlinks displayed on the graphical user interface 11.

In a step E2, the user touches a first specific element 102 corresponding to the hyperlink 2 of the graphical user interface 11 for the user wants to access to the electronic content toward which the hyperlink 2 is pointing.

In an embodiment of the method, when the user has selected the electronic content to be displayed by touching the specific element 102 of the graphical user interface 11 corresponding to the hyperlink 102, the selected electronic content 13 is downloaded and stored in a memory of the electronic device 10 during a step E3.

In another embodiment of the method, when the user has selected the electronic content to be displayed by touching the specific element 102 of the graphical user interface 11 corresponding to the hyperlink 102, the selected electronic content 13 is displayed in streaming mode on the electronic device 10, i.e. the information intended to be rendered on the electronic device 10 are transmitted, for example, from a server, but not stored in the electronic device 10.

A portion of the selected electronic content 13 is then displayed on the graphical user interface 11 during a step E4. The displayed portion of the selected electronic content 13 is overlapping the first electronic content 12 already displayed on the graphical user interface 11. Thus the user sees simultaneously both the first electronic content 12 and a portion of the selected electronic 13 content on the graphical user interface 11 as shown in FIG. 3.

The user of the electronic device 10 may modify, during a step E5, the measurement of the portion of the second electronic content 13 overlapping the first electronic content 12 in order to see a greater or a smaller portion of the second electronic content 13. The measurement of the portion of the second electronic content 13 to be displayed is proportional to the length of a sliding gesture or a pinch gesture executed by the user on the graphical user interface 11, the longer the sliding gesture the bigger the surface of the second electronic content 13 overlapping the first electronic content 12.

In a first embodiment of the method, in order to trigger the display of the whole electronic content 13 on the graphical user interface 11, the user touches a specific element 130 corresponding to an area of the graphical user interface where the portion of the second electronic content 13 is displayed, during a step E60.

Thus the user of the electronic device 10 only have to touch an area of the portion of the second electronic content 13 for the second electronic content 13 to be displayed on the graphical user interface 11 in instead of the first electronic content 12.

In a second embodiment of the method, if the sliding gesture is longer than a threshold, then the second electronic content 13 is considered selected by the user of the electronic device 10 and displayed on the graphical user interface 11 instead of the first electronic content 12 during a step E70.

FIG. 4 shows a diagram representing the steps of the method when it is run by the electronic device 10.

An electronic content 12 is displayed on the graphical user interface 11 of the electronic device 10. Such an electronic content 12 is for example a webpage displaying the result of a search executed by a search engine or the home page of an application such as a news application.

In a step F1, a first input on the specific element 102 of the graphical user interface 11 is detected by detecting component of the electronic device 10. The specific element 102 corresponds to the hyperlink 2 pointing toward the second electronic content 13.

An input can be a keystroke or a combination of keystrokes, a combination of keystroke and an action of the pointing device, e.g. highlighting a link currently displayed using the pointing device and striking a key of the keyboard.

In the case of touch-screens, an input can be a specific gesture on a specific area of the screen, such as a clutch gesture or a pinch gesture, etc.

In a step F2, the electronic content 13, toward which the hyperlink 2 associated to the specific element 102 for which an input is detected is pointing, is downloaded and stored in a hardware storing medium.

Such storing medium can be embedded in the electronic device 10 or in a remote device, such as a dedicated server, communicating with the electronic device 10 through a communication network.

In a step F3, a portion of the second electronic content 13 is displayed on the graphical user interface 11, said portion of the second electronic content 13 overlapping the first electronic content 12 as shown on FIG. 3.

In a step F4, a measurement of the portion of the second electronic content 13 overlapping the first electronic content 12 to be displayed is determined. The measurement of the portion of the second electronic content 13 to be displayed is proportional to an offset between a starting position of a third input on a third specific element 131 of the graphical user interface 11 and an ending position of the third input on a fourth specific element 132 of the graphical user interface 11 of the electronic device 10.

Thus, the second electronic content 13 moves from an edge of the graphical user interface 11 to the center of the graphical user interface 11, the surface of the second electronic content 13 overlapping the first electronic content 12 being proportional to the distance between the starting position of the third input on the third specific element 131 of the graphical user interface 11 and the ending position of the third input on the fourth specific element 132 of the graphical user interface 11.

When the third input is for example a sliding gesture, the surface of the second electronic content 13 overlapping the first electronic content 12 is proportional to the length of the sliding gesture; i.e. the longer the sliding gesture the bigger the surface overlapping the first electronic content.

In a step F5, the electronic device 10 determines if the ending position of the third input on the fourth specific element 132 of the graphical user interface 11 is beyond a threshold 133, as shown in FIG. 3.

If it the case, the display of the second electronic content 13 on the graphical user interface 11 of the electronic device 10 is triggered in a step F6. Thus, when step F6 is completed, the only electronic content displayed on the graphical user interface 11 is the second electronic content 13, for the first electronic content 12 is totally covered by the second electronic content 13.

In another embodiment, in a step F50, a second input on the specific element 131 of the graphical user interface 11 is detected. The detection of second input on the specific element 131 triggers, in a step F60, the display of the second electronic content 13 on the graphical user interface 11 of the electronic device 10.

In such an embodiment of the method, the user of the electronic device 10 only have to touch a specific element 131 of the portion of the second electronic content 13 already displayed for the second electronic content 13 to be displayed in instead of the first electronic content 12 on the graphical user interface 11.

FIG. 5 represents an electronic device 10 capable of executing the method for selecting an electronic content to be displayed objet of the disclosure.

Such an electronic device 10 comprises a display 110 controlled by a user interface 11. The user interface 11 can be for example a keyboard, or a keyboard and pointing device such as a mouse. In some embodiments of the electronic device 10, the display 110 and the user interface 11 can be one and the same, it is the case for example of touch-screens.

The user interface 11 comprises a plurality of specific elements 101-104 and 131-132, each of them being involved in triggering the execution of a specific function by the electronic device 10 when activated by a user of the electronic device 10.

A specific element of the user interface 11 can be a key of a key board, a combination of keys, a button of the pointing device, a specific area of a touch-screen, etc. Connected to the user interface 11, the electronic device comprises a component 20 for detecting an input on one of the specific elements 101-104 and 131-132 of the user interface 11.

An input can be a keystroke or a combination of keystrokes, a combination of keystroke and an action of the pointing device, e.g. highlighting a link currently displayed using the pointing device and striking a key of the keyboard.

In the case of touch-screens, an input can be a specific gesture on a specific area of the screen, such as a clutch gesture or a pinch gesture, etc.

The detecting component 20 is connected to a component 21 for downloading electronic contents selected using the specific elements 101-104 of the user interface 11.

The downloading component 21 is connected to storing medium 22 in which the selected electronic contents are stored after being downloaded.

The storing medium 22 is connected to a component 23 for measuring the portion of the second electronic content 13 overlapping the first electronic content 12 to be displayed. The measurement of the portion of the second electronic content 13 to be displayed is proportional to an offset between a starting position of a third input on a third specific element 131 of the graphical user interface 11 and an ending position of the third input on a fourth specific element 132 of the graphical user interface 11 of the electronic device 10.

The component 23 for measuring the portion of the electronic content 12 to be displayed are connected to a determining component 24 for determining if the ending position of the third input on the fourth specific element 132 of the graphical user interface 11 is beyond a threshold 133. The determining component 24 for determining if the ending position of the third input on the fourth specific element 132 of the graphical user interface 11 is beyond a threshold 133 is connected to the display 110.

Although the present disclosure has been described with reference to one or more examples, workers skilled in the art will recognize that changes may be made in form and detail without departing from the scope of the disclosure and/or the appended claims.

1. A method for selecting an electronic content to be displayed on a display of an electronic device controlled by means of a user interface, a first electronic content already being displayed on the display of the electronic device, said method comprising:
detecting a first input on a first specific element of the user interface, said specific element pointing toward at least a second electronic content to be displayed,
displaying at least a portion of the second electronic content on the display of the electronic device, said portion of the second electronic content overlapping the first electronic content, a measurement of the portion of the second electronic content to be displayed being proportional to an offset between a starting position of a second input on a second specific element of the user interface of the electronic device and an ending position of the second input on a third specific element of the user interface of the electronic device,
detecting a third input on a fourth specific element of the user interface, said detection triggering the display of the second electronic content on the display of the electronic device.

2. The method of claim 1, wherein the third specific element is a given area of the portion of the second electronic content overlapping the first electronic content.

3. The method of claim 1 comprising:
determining whether the ending position of the second input on the third specific element of the user interface is beyond a threshold,
if so, the third input being a release of the second input, triggering the display of the second electronic content on the display of the electronic device.

4. An electronic device controlled by a user interface and operable to select an electronic content to be displayed on a display of the electronic device on which a first electronic content already is displayed, the electronic device comprising means for:
detecting a first input on a first specific element of the user interface, said specific element pointing toward at least a second electronic content to be displayed,
displaying at least a portion of the second electronic content on the display, said portion of the second electronic content overlapping the first electronic content, a measurement of the portion of the second electronic content to be displayed being proportional to an offset between a starting position of a second input on a second specific element of the user interface of the electronic device and an ending position of the second input on a third specific element of the user interface of the electronic device,
detecting a third input on a third specific element of the user interface, said detection triggering the display of the second electronic content on the display of the electronic device.

5. A computer-readable hardware storage medium comprising a computer program stored thereon, which includes program code instructions for implementing a method for selecting an electronic content to be displayed on a display of an electronic device controlled by a user interface, a first electronic content already being displayed on the display of the electronic device, when the program is executed by a processor, said method comprising:
detecting a first input on a first specific element of the user interface, said specific element pointing toward at least a second electronic content to be displayed,
displaying at least a portion of the second electronic content on the display of the electronic device, said portion of the second electronic content overlapping the first electronic content, a measurement of the portion of the second electronic content to be displayed being proportional to an offset between a starting position of a second input on a second specific element of the user interface of the electronic device and an ending position of the second input on a third specific element of the user interface of the electronic device,
detecting a third input on a fourth specific element of the user interface, said detection triggering the display of the second electronic content on the display of the electronic device.
